(19) United States
(12) Patent Application Publication
(10) Pub. No.: US 2011/0282843 A1
(43) Pub. Date: Nov. 17, 2011

(54) METHOD AND SYSTEM FOR DATA BACKUP AND REPLICATION

(75) Inventors: Xiaopin (Hector) Wang, Beijing (CN); Haiyang Zhang, Beijing (CN); Shaorong Li, Beijing (CN)

(73) Assignee: COMPUTER ASSOCIATES THINK, INC., Islandia, NY (US)

(21) Appl. No.: 12/781,417

(22) Filed: May 17, 2010

(51) Int. Cl. G06F 12/16; G06F 17/30

(52) U.S. Cl. 707/649; 707/E17.005

(57) ABSTRACT

A work flow is initiated and identified by a scenario identifier. A file system driver is notified to record operations on data associated with the work flow identified by the scenario identifier as raw journals without recording data content associated with the operations. The recorded operations are consolidated with previous operations as each operation is recorded in the raw journals. A system snapshot is initiated to be taken. The file system driver is notified of a point in time the system snapshot is taken. Data content associated with the consolidated recorded operations is retrieved from the system snapshot. A first packet is created from selected recorded operations and sent synchronously. A second packet including rest of the recorded operations along with associated data content are sent asynchronously with the point in time of the system snapshot.

### FIELD

The present disclosure relates generally to computer systems, backup and recovery systems, and more particularly to data backup and replication.

### BACKGROUND

Computer files and/or directories should be backed-up in a consistent state at least periodically. That is, the contents should not change while the backup is being made. A shadow volume copy is a copy of storage volume, for example, for backing-up data or files on the volume. The Volume Shadow Copy Service (VSS) is a Windows™ operating system utility that can be used to create a shadow copy. The VSS command, for example, may be issued to take a volume snapshot periodically, for example, every fifteen minutes to ensure that all application data and cache in the file system are flushed to disk.

The difference between the last snapshot and the current snapshot may be determined and sent to a backup system. The challenge, however, has been the performance of capturing the difference between two snapshots, for example, and optimizing the redundancy in the differences.

A minifilter file system driver may include the capability to capture every file and/or directory operation in a real time manner. However, such driver may lack the mechanism to know the exact time point of the consistent state during a snapshot in order to insert a bookmark automatically for the consistent state in the journal event sequence. The consistent state refers to the state of the data on the volume when the snapshot was taken. The exact time point of the snapshot may be used for recovery. For instance, data can be restored to any such point at which the data is application consistent, i.e., the restored data are equal to those of the snapshots at that time point. A consistent state means that a VSS snapshot contains all application consistent data which are flushed from memory and file system to disks prior to building the snapshot.

### BRIEF SUMMARY

A method and system for data backup and replication are provided. The method, in one aspect, may include initiating a work flow and identifying the work flow by a scenario identifier and notifying a file system driver to record operations on data associated with the work flow identified by the scenario identifier as raw journals without recording data content associated with the operations. The method may also include consolidating the recorded operations with previous operations as each operation is recorded in the raw journals. The method may further include initiating a system snapshot to be taken and notifying the file system driver of a point in time the system snapshot is taken. The method may yet further include retrieving from the system snapshot data content associated with the consolidated recorded operations. The method also include selecting one or more or combinations of truncate, rename, remove, or create operations from the consolidated recorded operations and creating a first packet including the selected operations, and sending the first packet synchronously to a replication server. The method may further include creating a second packet including the consolidated recorded operations not selected for the first packet, and the associated data content from the system snapshot. The method may further include inserting the point in time the system snapshot is taken into the second packet and sending the second packet asynchronously to the replication server.

A system for data backup and replication, in one aspect, may include a production server operable to initiate a work flow and identify the work flow by a scenario identifier. A file system driver may be operable to capture notification from the production server to record operations on data associated with the work flow identified by the scenario identifier as raw journals without recording data content associated with the operations. The production server may be further operable to consolidate the recorded operations with previous operations as each operation is recorded in the raw journals, the production server further operable to initiate a system snapshot to be taken and notify the file system driver of a point in time the system snapshot is taken. The production server may be further operable to retrieve from the system snapshot data content associated with the consolidated recorded operations, the production server further operable to select one or more or combinations of truncate, rename, remove, or create operations from the consolidated recorded operations and create a first packet including the selected operations. The production server may be further operable to send the first packet synchronously to a replication server, the production server further operable to create a second packet including the consolidated recorded operations not selected for the first packet, and the associated data content from the system snapshot. The production server may be also operable to insert the point in time the system snapshot is taken into the second packet, and send the second packet asynchronously to the replication server.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is an architectural diagram illustrating scheduled replication in one aspect of the present disclosure.

FIG. 2 illustrates event data that are stripped from raw journal.

FIG. 3 illustrates a work flow of the Master in one embodiment of the present disclosure.

### DETAILED DESCRIPTION

Backup and recovery systems such as CA™ XOSoft™ may have mini filter driver components with the capability to capture every file and/or directory operation in a real time manner. Those drivers, however, may lack the mechanism to know the exact time point of the consistent state during a snapshot in order to insert a bookmark automatically for the consistent state in the journal event sequence. Journal events include one or more events that operate on data volume, for example, files and/or directories. Those events are recorded as journal events. Journal events between two snapshots may represent the differences between the two snapshot copies. A snapshot refers to a copy of system configuration data at a given time.

The method of the present disclosure may be incorporated into a backup and recovery system. For instance, a system or server to be backed up (e.g., a production server herein referred to as Master) may trigger a VSS snapshot periodically.

Initial synchronization includes comparing the difference between a production server (referred to herein as Master) and a replication server (referred to herein as Replica), and sending these differences. Initial synchronization may occur in different ways. For example, one embodiment of initial synchronization compares and sends all file content read from the snapshots. No matter how many file and/or directory updates occur under the protected directories during synchronization, the data for comparing and sending are read from snapshots which are not affected by these changes. Thus it natively ensures that the Replica gets the consistent state base corresponding to the “beginning” of the synchronization.

In another embodiment, the initial synchronization may use the snapshots for a short period of time to build a directory structure that only contains the file and/or directory path and name read from the snapshots. Then the snapshots are removed. The comparison process between the Master and the Replica enumerates all file and/or directory full path from the built directory structure, and reads the file content from the original volumes that reflect the current data changes. If some contents (read from the original volumes and what Replica has) are different, these parts are sent to the Replica. After synchronization, the Replica usually gets an inconsistent base due to file/directory operations under the protected directories during the synchronization process. So an immediate replication is triggered to send and apply all these consolidated changes to Replica. A consistency bookmark is also sent at the end of the of the immediate replication, after which the Replica gets a consistent base corresponding to the “end” of synchronization.

A mini filter of the backup and recovery system may continue to monitor any file operation to generate journal events almost as before. But the WRITE event does not record the real data updated this time. It only needs to record the range of changed data so that the event is much slimmer. When the time of creating a snapshot comes, the driver can know all data are flushed upon the completion of I/O control code IOCTL_VOLSNAP_FLUSH_AND_HOLD_WRITES which is sent by VSS service (vssvc.exe) at which time it can insert a bookmark to indicate the consistent state safely. That is, Master has a VSS requestor that first adds all volumes containing the data protected to a snapshot set. These volumes are also informed or notified to the filter driver. Then the requestor invokes VSS service to do snapshots for the snapshot set. VSS service subsequently informs all application VSS writes to flush data to disk. After the completion of data flushing, VSS service notifies the file system to flush its data as well as metadata to disk prior to suspending I/O. The filter driver can capture this I/O notification IOCTL_VOLSNAP_FLUSH_AND_HOLD_WRITES in the middle when the file system completes the execution of this code and returns the results to the caller. The bookmark is inserted into the journal events. For example, before the I/O control code, lots of WRITE events maybe generated. Then the bookmark is inserted after them. After all snapshots are done, other events like WRITE events are generated following the bookmark.

Master checks the journal events generated during the period (between two bookmarks) after the snapshot and subsequently consolidates the events to remove redundancy prior to transferring the consolidated event sequence to Replica. It may read file data from the snapshot so as to generate the consolidated WRITE event since the actual data in the last updates for a file need to be incorporated in the final WRITE event. After that, the snapshot can be removed.

The backup and recovery system can back up protected directories in a consistent manner periodically with much less storage space for the journal WRITE events generated between two snapshots.

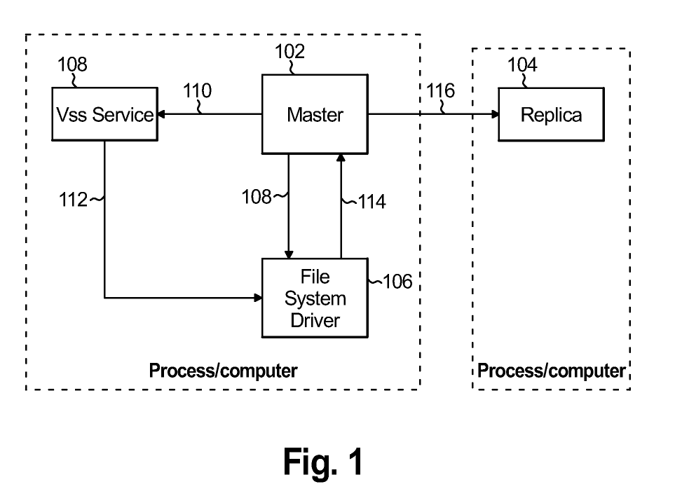

FIG. 1 is an architectural diagram illustrating scheduled replication utilized in one aspect of the present disclosure. Master component 102 shown in FIG. 1 may be a server logic, which is part of a computer system including, for example, hardware components such as processors and other processing elements, memory, network interface device, and other components. VSS service 108 may be another programming logic that is executing on the computer system. File system driver 106 also may execute or run on the computer system and interact with the computer system's operating system and disk drives to read, write and store data on the disks associated with the computer system. Replica 104 may be another server, for instance, running on a different computer system acting as a backup server to the Master 102. A person of ordinary skill in this technology will appreciate that other components (e.g., hardware and software) may be included in the computer system and/or servers that perform backup and recovery of computer system and data.

The Master 102 inserts a user event to indicate a scenario identifier (“id”) at 102. For instance, the Master 102 notifies the file system driver (e.g., mini-filter driver) and the file system driver includes the scenario id into a consistency bookmark (i.e., a data structure that indicates a point in time of a snapshot). A scenario is a job or task that protects the data belonging to applications or directories. Master can run multiple scenarios to replicate data to different Replicas. A scenario id is a unique attribute of a scenario that differentiates this scenario to others. The Master 102 fires up a snapshot, e.g., by invoking a VSS service 108 as shown at 110. The VSS service 108 notifies the file system 106 to flush cached data and hold file operation as shown as 112, for instance, according to the VSS protocol.

A file system driver 106 of a file system such as a mini filter driver may insert the consistency bookmark at this time with the scenario id previously assigned by the Master 102. The consistency bookmark is inserted into the journal event sequence explained above to allow rewinding back to this consistent state by following the undo events (e.g, counterpart of journal events). The scenario id uniquely identifies the scenario. There may be many scenarios running in Master. Every journal event along with the consistency bookmark has a field to contain the scenario id so that undo events as well as consistency bookmarks can be grouped by scenario id. The Master 102 consolidates the event sequences between two adjacent consistency bookmarks on the fly as shown at 114. These events are captured by the filter driver. For example, if a file is updated, the filter driver can be informed of the update, and correspondingly generate WRITE events for the modified file contents. Master periodically triggers VSS service. During VSS taking snapshots, the filter driver can capture the exact point in time explained above to generate a consistency bookmark. These events are sorted in order by time so that two adjacent consistency bookmarks refer to the two adjacent consistency bookmarks in time.

The Mater 102 sends events such as create, rename, remove to the Replica 104 as shown at 116. Master can get these events from the filter driver and send them to Replica. Replica can apply these events to replicate the difference between Master and Replica together with the option to generate undo events. Then it reads changed data blocks and directory and file security information from the snapshot which are sent to Replica asynchronously in the journal format prior to releasing the snapshot.

Operating systems such as Windows™ include security information that contain many bytes. WRITE events also include many data. Although the filter driver can capture these events, it hits performance when records them to disk due to a large number of additional I/O. That is, applications under capturing run slower. Therefore, in one aspect, the filter driver does not record the changed data blocks and Windows™ security information in events. Rather, it just records the changed range for WRITE events and the fact that Windows™ security has been updated. Later on, Master 102 reads them from VSS snapshots prior to sending the Replica.

The Master 102 also sends the consistency bookmark, for instance, for data rewind. Replica 104 records undo events which can be shown in a graphical user interface (GUI). Consistency bookmarks are among the events shown, so that for example users can rewind data to a consistent state by selecting a consistency bookmark to rewind to. Master 102 gets the consistency bookmarks from the filter driver.

After starting the scenario, the file system driver may continue to capture journal events for the scenario. Write and change security events only record their event headers in contrast to originally recorded event data. Change manager consolidates the dirty data range by aggregating related write events on the fly. Change manager is a component that consolidates changed data. For example, a file is updated in the offsets (3, 7) and (4, 10). Change Manager consolidates the two operations to (3, 10). Dirty data range is the offset range that a file is modified. At the next synchronization time, a VSS snapshot is taken so that dirty data can be read from the snapshot prior to sending to Replica. That is, Master 102 forms the complete events for WRITE and changes security. Before the Master 102 forms the complete events, those events only contain header part and thus are incomplete. Master 102 reads the dirty data from the snapshot since Master 102 only knows from the filter driver the changed file offset ranges and the fact that securities of some files have been changed. Thus, Master 102 reads out the actual contents from the snapshots prior to sending these events to Replica.

A consistent bookmark at the snapshot is expected to be inserted to the journal event sequence for the ease of recovery. This can be done from the file system driver since it knows the time point that VSS service notifies that a snapshot is taken. The consistency bookmark can ensure that all applications (having VSS writer) protected are in a consistent state. A bookmark may be represented as an event object or a data structure, for example, instantiated by a class in an object oriented programming. Other file and directory manipulations captured by the filter driver are also kind of event objects.

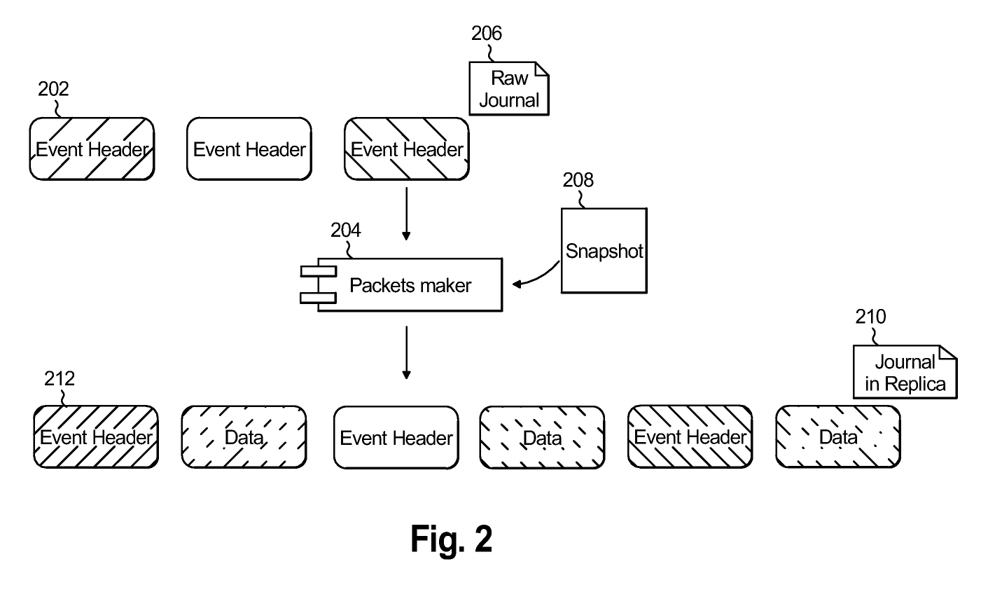

FIG. 2 illustrates event data that are stripped from raw journal. The event header 202 is the header part of an event that contains attributes of the journal event, e.g. event size, event type. Packets maker 204 is a component that combines journal event header from the consolidated journal files and journal event data from the snapshots, and sends them separated by package via the network. Raw journal 206 is a file that contains many journal event headers captured by the filter driver. Snapshots 208 are taken by VSS and triggered by a request in Master. Journal in Replica 210 is a file that contains many journal events which include both header part and data part. The sequence of event header and data shown at 212 is the complete representation of file/directory changes between two adjacent consistency bookmarks.

When the time of creating a snapshot comes, a file system driver knows that all data are flushed upon the completion of I/O control code IOCTL_VOLSNAP_FLUSH_AND_HOLD_WRITES which is sent by VSS service (vssvc.exe). At this time, the file system driver may insert a bookmark to indicate the consistent state safely. Thus, for example, the Master may insert a special user event (e.g., the scenario id) before firing up a VSS snapshot. When the file system driver receives the user event, it enumerates all volumes in the group to see which volumes include a root directory belonging to the scenario. If one or more volumes include a root directory belonging to the scenario, the file system driver records the scenario id in the volumes' local storage. In one aspect, the file system driver does not record the user event to the raw journal file. When VSS notifies the file system to flush data and hold I/O, the file system driver captures the completion of the I/O control operation and inserts another special user event to indicate the consistency bookmark. The scenario id is packed in the bookmark read from the volume local storage. To users, the user event is a regular event with the name called consistency bookmark. Eventually, the consistency bookmark will be received by Replica.

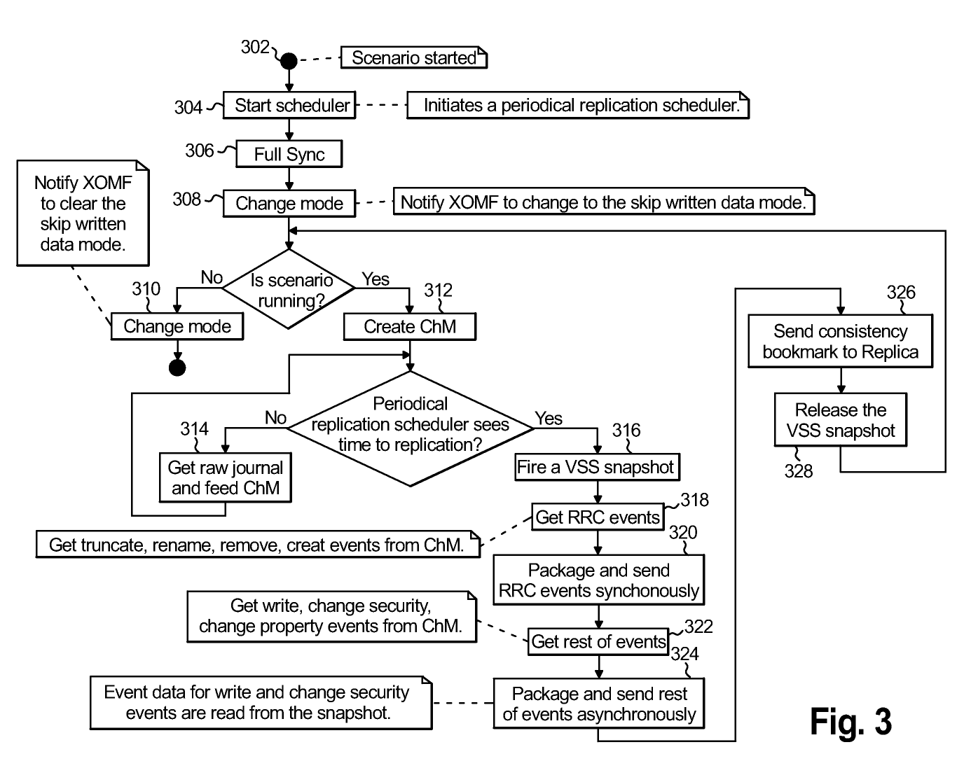

FIG. 3 illustrates a work flow of the Master in one embodiment of the present disclosure. At 302, a scenario is started. For instance, a user may start a scenario by clicking a run scenario button in a graphical user interface (GUI). It marks the beginning of the work flow. At 304, a periodic replication scheduler is started. A periodic replication scheduler is a component or module that periodically triggers a round of periodic replication. At 306, full synchronization is performed. The full synchronization compares the difference between Master and Replica and transfers the difference from Master to Replica. Replica applies these differences to make the backed up data the same with the data at Master.

At 308, the Master notifies the file system driver to switch to skip written data mode. In this mode, the file system driver does not record data for write and change security event. The skip written data mode of the present disclosure tells the filter driver not to record the data part. Thus, in this mode, the filter driver does not record the data part of journal events. Before switching to this mode, the filter driver may have recorded the data part of journal events and the Master may have sent these journals events immediately to Replica for online replication, for example, for continuous data protection. In such cases, the Master did not consolidate the data part with the rest of the journal events.

If scenario is not running, at 310, the Master notifies the file system driver to clear the skip written data mode. That is, if the scenario is not running at this stage, the mode should be restored to the original mode.

Otherwise, if scenario is running, the logic flows to 312 in which a Change Manager is created or instantiated to perform consolidation of changes. For instance, Master may instantiate the Change Manager object. The Master queries the file system periodically, for example, every 3 second, to get raw journals at 314. The raw journals as described above include journal event headers captured by the filter driver. In the processing of raw journals, the Master feeds the raw journal to a journal consolidator which then translates the event and passes it to Change Manager. A journal consolidator is a component that translates the journal event header from the filter driver to a format that the Change Manager can understand prior to informing the Change Manager to consolidate changes.

A user may specify an interval or period for performing replication, for instance, using a GUI. The interval may be stored in the scenario configuration file associated with the scenario. If the periodic replication scheduler detects that is time for replication, the logic flows continues to 316. At 316, the periodic replication scheduler (i.e., Master) invokes VSS snapshot and sends the consolidated events from the journal consolidator via the Change Manager to Replica conforming to the journal format.

At 318, events such as truncate, rename, remove, create are obtained from the Change Manager. For example, the Master periodically (e.g., every three seconds by default) pulls or retrieves the raw journals from the file system driver and then sends the raw journals to the journal consolidator, which then routes it to the Change Manager.

At 320, the events obtained at 318 are packaged and sent synchronously.

At 322, the rest of the events, for example, write, change security, change property events and others not obtained at 318 are obtained from the Change Manager. In addition, event data for write and change security events are read from the snapshot. A new packet maker reads data part (in contrast to event header) from the snapshot for write and change security events prior to forming a packet. This may be done using a content map that maps the data part of journal events to snapshots. A content map entry represents one journal event, which records the event header part and references the event data part to the snapshots. At 324, the rest of the events and event data are packaged and sent asynchronously.

At 326, the consistency bookmark is packed in the end of journal consolidator and is sent to Replica in the end. Change Manager eventually provides two kinds of events. The first contains truncate, rename, remove and create events that are sent synchronously, i.e. getting the ACK (acknowledgment) from Replica prior to dealing with the next content map. The second contains write, change attribute and change security events which can be executed in any order and thus can be sent asynchronously.

In forming a packet, asynchronous journal sending may enhance performance. For instance:

1. Get the first kind of events.
2. Write these events to a content map.
3. Send the content map synchronously.
4. Get the second kind of events.
5. Write these events to multiple content maps (if needed), for example, 1 megabyte as a unit.
6. Send these content maps asynchronously.
7. Wait for all ACKs and resend failed ones.
8. Write the consistency bookmark (user event) to a content map and send it synchronously.

The work flow of FIG. 3 illustrates the backup part in Master. Generally, the Master initially synchronizes the difference between Master and Replica. Then Master continuously monitoring all file/directory changes and consolidates the change operations on the fly. Master periodically triggers a replication that sends all consolidated changes during this period to Replica. Consistency bookmarks are generated in each round of replication to represent the consistent state of the VSS point in time. Upon receiving the changes, Replica applies them to its backup root directories to keep the same with Master's. These changes are represented by journal events and can be displayed in GUI. Replica also generates undo journal events that be used to rewind to either a specific event or a consistency bookmark.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for data backup and replication, comprising:
initiating a work flow, using a processor, and identifying the work flow by a scenario identifier;
notifying a file system driver to record operations on data associated with the work flow identified by the scenario identifier as raw journals without recording data content associated with the operations;
consolidating the recorded operations with previous operations as each operation is recorded in the raw journals;
initiating a system snapshot to be taken;
notifying the file system driver of a point in time the system snapshot is taken;
retrieving from the system snapshot data content associated with the consolidated recorded operations;
selecting one or more or combinations of truncate, rename, remove, or create operations from the consolidated recorded operations and creating a first packet including the selected operations;
sending the first packet synchronously to a replication server;
creating a second packet including the consolidated recorded operations not selected for the first packet, and the associated data content from the system snapshot;
inserting the point in time the system snapshot is taken into the second packet; and
sending the second packet asynchronously to the replication server.

2. The method of claim 1, wherein the steps of consolidating the recorded operations, initiating a system snapshot to be taken, notifying the file system driver of a point in time the system snapshot is taken, retrieving from the system snapshot, selecting one or more or combinations of truncate, rename, remove, or create operations, sending the first packet synchronously, creating a second packet, inserting the point in time the system snapshot, and sending the second packet, are performed while the work flow is running.

3. The method of claim 2, wherein in response to determining that the work flow is not running, notifying the file system driver to switch to a normal mode in which operations on data is recorded with associated data content changes.

4. The method of claim 1, wherein the step of initiating a system snapshot to be taken is performed periodically.

5. The method of claim 4, wherein the steps of notifying the file system driver of a point in time the system snapshot is taken, retrieving from the system snapshot, selecting one or more or combinations of truncate, rename, remove, or create operations, sending the first packet synchronously, creating a second packet, inserting the point in time the system snapshot, and sending the second packet, are performed in response to and each time the system snapshot is taken.

6. The method of claim 4, wherein the step of initiating a system snapshot to be taken is performed periodically based on user specified interval.

7. The method of claim 1, wherein the consolidated recorded operations not selected for the first packet includes one or more or combinations of write, change security, change property operations.

8. A computer readable storage medium storing a program of instructions executable by a machine to perform a method of data backup and replication, comprising:
initiating a work flow, using a processor, and identifying the work flow by a scenario identifier;
notifying a file system driver to record operations on data associated with the work flow identified by the scenario identifier as raw journals without recording data content associated with the operations;
consolidating the recorded operations with previous operations as each operation is recorded in the raw journals;
initiating a system snapshot to be taken;
notifying the file system driver of a point in time the system snapshot is taken;
retrieving from the system snapshot data content associated with the consolidated recorded operations;
selecting one or more or combinations of truncate, rename, remove, or create operations from the consolidated recorded operations and creating a first packet including the selected operations;
sending the first packet synchronously to a replication server;
creating a second packet including the consolidated recorded operations not selected for the first packet, and the associated data content from the system snapshot;
inserting the point in time the system snapshot is taken into the second packet; and
sending the second packet asynchronously to the replication server.

9. The computer readable storage medium of claim 8, wherein the steps of consolidating the recorded operations, initiating a system snapshot to be taken, notifying the file system driver of a point in time the system snapshot is taken, retrieving from the system snapshot, selecting one or more or combinations of truncate, rename, remove, or create operations, sending the first packet synchronously, creating a second packet, inserting the point in time the system snapshot, and sending the second packet, are performed while the work flow is running.

10. The computer readable storage medium of claim 9, wherein in response to determining that the work flow is not running, notifying the file system driver to switch to a normal mode in which operations on data is recorded with associated data content changes.

11. The computer readable storage medium of claim 8, wherein the step of initiating a system snapshot to be taken is performed periodically.

12. The computer readable storage medium of claim 11, wherein the steps of notifying the file system driver of a point in time the system snapshot is taken, retrieving from the system snapshot, selecting one or more or combinations of truncate, rename, remove, or create operations, sending the first packet synchronously, creating a second packet, inserting the point in time the system snapshot, and sending the second packet, are performed in response to and each time the system snapshot is taken.

13. The computer readable storage medium of claim 11, wherein the step of initiating a system snapshot to be taken is performed periodically based on user specified interval.

14. The computer readable storage medium of claim 8, wherein the consolidated recorded operations not selected for the first packet includes one or more or combinations of write, change security, change property operations.

15. A system for data backup and replication, comprising:
a production server operable to initiate a work flow and identify the work flow by a scenario identifier;
a file system driver operable to capture notification from the production server to to record operations on data associated with the work flow identified by the scenario identifier as raw journals without recording data content associated with the operations;
the production server further operable to consolidate the recorded operations with previous operations as each operation is recorded in the raw journals, the production server further operable to initiate a system snapshot to be taken and notify the file system driver of a point in time the system snapshot is taken, the production server further operable to retrieve from the system snapshot data content associated with the consolidated recorded operations, the production server further operable to select one or more or combinations of truncate, rename, remove, or create operations from the consolidated recorded operations and create a first packet including the selected operations, the production server further operable to send the first packet synchronously to a replication server, the production server further operable to create a second packet including the consolidated recorded operations not selected for the first packet, and the associated data content from the system snapshot, the production server further operable to insert the point in time the system snapshot is taken into the second packet, and send the second packet asynchronously to the replication server.

16. The system of claim 15, wherein the production server consolidates the recorded operations, initiates a system snapshot to be taken, notifies the file system driver of a point in time the system snapshot is taken, retrieves from the system snapshot, selects one or more or combinations of truncate, rename, remove, or create operations, sends the first packet synchronously, creates a second packet, inserts the point in time the system snapshot, and sends the second packet, while the work flow is running.

17. The system of claim 16, wherein in response to determining that the work flow is not running, the production server notifies the file system driver to switch to a normal mode in which operations on data is recorded with associated data content changes.

18. The system of claim 15, wherein the production server initiates a system snapshot to be taken periodically.

19. The system of claim 18, wherein the production server notifies the file system driver of a point in time the system snapshot is taken, retrieves from the system snapshot, selects one or more or combinations of truncate, rename, remove, or create operations, sends the first packet synchronously, creates a second packet, inserts the point in time the system snapshot, and sends the second packet, in response to and each time the system snapshot is taken.

20. The system of claim 18, wherein the production server initiates a system snapshot to be taken periodically based on user specified interval.

21. The system of claim 15, wherein the consolidated recorded operations not selected for the first packet includes one or more or combinations of write, change security, change property operations.
